(19) United States
(12) Patent Application Publication
(10) Pub. No.: US 2009/0161757 A1
(43) Pub. Date: Jun. 25, 2009

(54) Method and Apparatus for Selecting a Coding Mode for a Block

(75) Inventors: Yue Yu, San Diego, CA (US); Limin Wang, San Diego, CA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/962,914

(22) Filed: Dec. 21, 2007

(51) Int. Cl. H04N 7/26

(52) U.S. Cl. 375/240.03; 375/240.02; 375/E07.14

(57) ABSTRACT

A method and apparatus for processing an input image are disclosed. For example, the method receives a block of pixels from the input image, and selects a coding mode for the block of pixels based on at least one coding mode of at least one neighbor block of the block of pixels. The method determines whether the coding mode will result in all zero coefficients for the block of pixels, and selects the coding mode for the block of pixels if the coding mode will result in all zero coefficients for the block of pixels.

### BACKGROUND OF THE INVENTION

1. Field of the Invention

The present invention relates to video encoders and, more particularly, to a method and apparatus for selecting a coding mode for a block, e.g., a block in a current frame to be encoded.

2. Description of the Background Art

The International Telecommunication Union (ITU) H.264 video coding standard is able to compress video much more efficiently than earlier video coding standards, such as ITU H.263, MPEG-2 (Moving Picture Experts Group), and MPEG-4. H.264 is also known as MPEG-4 Part 10 and Advanced Video Coding (AVC). H.264 exhibits a combination of new techniques and increased degrees of freedom in using existing techniques. Among the new techniques defined in H.264 are 4×4 and 8×8 discrete cosine transform (DCT). Since transformed quantized coefficients are used to form the final outputs of the encoding process, and since various encoding functions (e.g., motion estimation, intra prediction, and mode selection) involve numerous coefficient calculations, it is helpful to be able to quickly determine a coding mode for a block.

### SUMMARY OF THE INVENTION

In one embodiment, the present invention discloses a method for processing an input image. For example, the method receives a block of pixels from the input image, and selects a coding mode for the block of pixels based on at least one coding mode of at least one neighbor block of the block of pixels. The method determines whether the coding mode will result in all zero coefficients for the block of pixels, and selects the coding mode for the block of pixels if the coding mode will result in all zero coefficients for the block of pixels.

In one embodiment, the present invention discloses a computer readable medium having stored thereon instructions that when executed by a processor cause the processor to perform a method for processing an input image. For example, the method receives a block of pixels from the input image, and selects a coding mode for the block of pixels based on at least one coding mode of at least one neighbor block of the block of pixels. The method determines whether the coding mode will result in all zero coefficients for the block of pixels, and selects the coding mode for the block of pixels if the coding mode will result in all zero coefficients for the block of pixels.

In one embodiment, the present invention discloses an apparatus for processing an input image. For example, the apparatus comprise a memory for receiving a block of pixels from the input image. The apparatus comprises a processor for selecting a coding mode for the block of pixels based on at least one coding mode of at least one neighbor block of the block of pixels, for determining whether the coding mode will result in all zero coefficients for the block of pixels, and for selecting the coding mode for the block of pixels if the coding mode will result in all zero coefficients for the block of pixels.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a block diagram depicting an illustrative embodiment of a video encoder;

FIG. 2 illustrates a block diagram showing a plurality of neighboring blocks;

FIG. 3 illustrates a flow diagram depicting an illustrative embodiment of a method for determining a coding mode for a block in accordance with one or more aspects of the invention; and

FIG. 4 illustrates a block diagram depicting an illustrative embodiment of a video encoder in accordance with one or more aspects of the invention.

To facilitate understanding, identical reference numerals have been used, where possible, to designate identical elements that are common to the figures.

### DETAILED DESCRIPTION OF THE INVENTION

Method and apparatus for implementing a video encoder is described. More specifically, the present invention discloses an implementation of an encoder, e.g., an H.264 encoder, that is capable of quickly selecting a coding mode for a block.

More specifically, H.264 or MPEG4 Part 10 (AVC) offers several coding modes for both intra and inter macroblocks (MBs) to achieve better encoding performance. Furthermore, each macroblock can be further divided into sub-blocks, e.g., sixteen 4×4 blocks or four 8×8 blocks. As such, for the intra mode, each macroblock can be coded as an intra_{—}16×16 block, a plurality of intra_{—}8×8 blocks, or a plurality of intra_{—}4×4 blocks. To provide even greater flexibility, each block size has a plurality of prediction directions. For example, for intra_{—}16×16, there are four (4) different prediction directions while there are nine (9) different prediction directions for intra_{—}4×4 and intra_{—}8×8. Thus, in order to select a coding mode for a block, the encoder may have to expend a large number of computational cycles to reach a conclusion as to which coding mode will be the most efficient coding mode. For example, a brute force approach may simply encode each block using all of the available coding modes and then deciding which coding mode is the most effective in terms of compression efficiency and distortion measure. However, there are scenarios where it may not be practical due to insufficient processing resources and/or insufficient time (e.g., in real time application) to expend such large number of computational cycles to derive the optimal coding mode for a block of a current frame to be encoded by an encoder.

To address this criticality, the present invention provides a method that is able to quickly determine a coding mode (e.g., a selected coding mode from among a plurality of available coding modes) for a block while minimizing the computational cycles needed to arrive at the selected coding mode. To assist in the understanding of the present invention, a brief description of the various encoding functions performed by an illustrative H.264 encoder or an H.264-like encoder is first described.

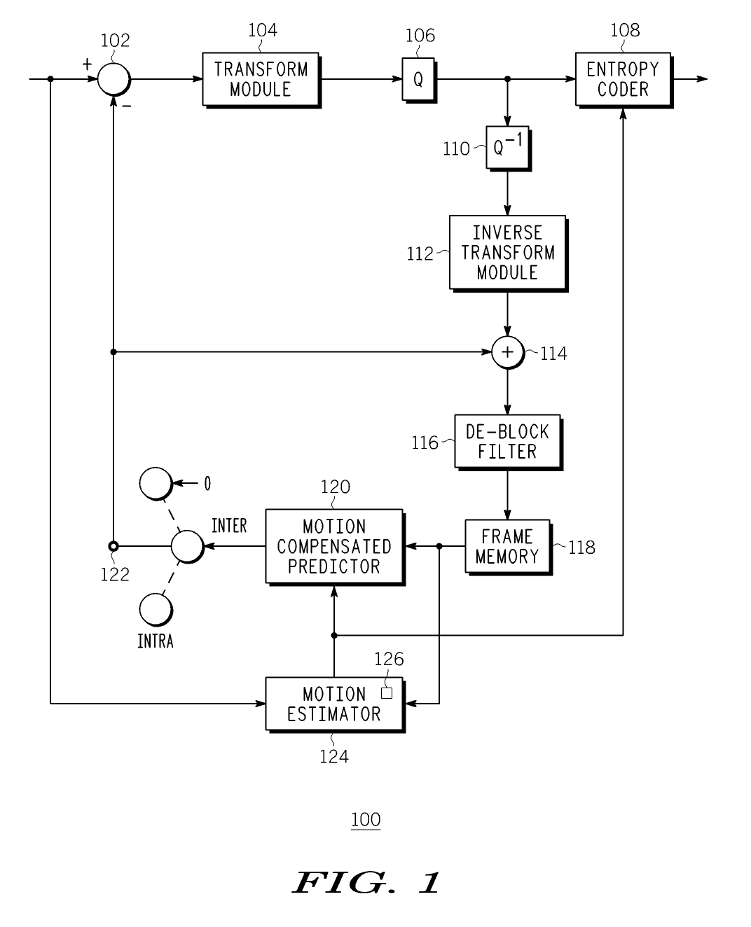

FIG. 1 is a block diagram depicting an exemplary embodiment of a video encoder 100. Since FIG.1 is intended to only provide an illustrative example of a H.264 encoder, FIG. 1 should not be interpreted as limiting the present invention. For example, the video encoder 100 is compliant with the H.264 standard or the Advanced Video Coding (AVC) standard. The video encoder 100 may include a subtractor 102, a transform module, e.g., a discrete cosine transform (DCT) like module 104, a quantizer 106, an entropy coder 108, an inverse quantizer 110, an inverse transform module, e.g., an inverse DCT like module 112, a summer 114, a deblocking filter 116, a frame memory 118, a motion compensated predictor 120, an intra/inter switch 122, and a motion estimator 124. It should be noted that although the modules of the encoder 100 are illustrated as separate modules, the present invention is not so limited. In other words, various functions (e.g., transformation and quantization) performed by these modules can be combined into a single module. In operation, the video encoder 100 receives an input sequence of source frames. The subtractor 102 receives a source frame from the input sequence and a predicted frame from the intra/inter switch 122. The subtractor 102 computes a difference between the source frame and the predicted frame, which is provided to the DCT module 104. In INTER mode, the predicted frame is generated by the motion compensated predictor 120. In INTRA mode, the predicted frame is zero and thus the output of the subtractor 102 is the source frame.

The DCT module 104 transforms the difference signal from the pixel domain to the frequency domain using a DCT algorithm to produce a set of coefficients. The quantizer 106 quantizes the DCT coefficients. The entropy coder 108 codes the quantized DCT coefficients to produce a coded frame.

The inverse quantizer 110 performs the inverse operation of the quantizer 106 to recover the DCT coefficients. The inverse DCT module 112 performs the inverse operation of the DCT module 104 to produce an estimated difference signal. The estimated difference signal is added to the predicted frame by the summer 114 to produce an estimated frame, which is coupled to the deblocking filter 116. The deblocking filter deblocks the estimated frame and stores the estimated frame or reference frame in the frame memory 118. The motion compensated predictor 120 and the motion estimator 124 are coupled to the frame memory 118 and are configured to obtain one or more previously estimated frames (previously coded frames).

The motion estimator 124 also receives the source frame. The motion estimator 124 performs a motion estimation algorithm using the source frame and a previous estimated frame (i.e., reference frame) to produce motion estimation data. For example, the motion estimation data includes motion vectors and minimum SADs (sum of absolute differences) for the macroblocks of the source frame. The motion estimation data is provided to the entropy coder 108 and the motion compensated predictor 120. The entropy coder 108 codes the motion estimation data to produce coded motion data. The motion compensated predictor 120 performs a motion compensation algorithm using a previous estimated frame and the motion estimation data to produce the predicted frame, which is coupled to the intra/inter switch 122. Motion estimation and motion compensation algorithms are well known in the art.

To illustrate, the motion estimator 124 may include mode decision logic 126. The mode decision logic 126 can be configured to select a mode for each macroblock in a predictive (INTER) frame. The “mode” of a macroblock is the partitioning scheme. That is, the mode decision logic 126 selects MODE for each macroblock in a predictive frame, which is defined by values for MB_TYPE and SUB_MB_TYPE.

The above description only provides a brief view of the various complex algorithms that must be executed to provide the encoded bitstreams generated by an H.264 encoder. The increase in complexity is often a result of a desire to provide better encoding characteristics, e.g., less distortion in the encoded images while using less number of bits to transmit the encoded images. In order to achieve these improved encoding characteristics, it is often necessary to increase the overall computational overhead of an encoder. Unfortunately, the increase in computational overhead also increases the difficulty in implementing a real-time H.264 encoder. As such, the present invention provides a method that is capable of quickly determining a coding for a block of a current frame to be encoded. For example, an intra predictor may implement the present method.

More specifically, in H.264/AVC video coding standard, coefficients are computed by transforming and quantizing a set of pixels known as the “residuals”. As such, for the purpose of the present invention, transformed coefficients pertain to pixel values (e.g., values in the residual signal) that have undergone a transformation process and quantized coefficients pertain to transformed coefficients that have undergone a quantization process. For example, the residual pixels may be obtained by subtracting two sets of 4×4 pixel regions that depend on the implementation as well as the section of the encoding process. For example, during intra mode selection, the residuals are obtained by subtracting the predicted pixels from the original; while during motion estimation, the residuals are the difference of the reconstructed pixels of reference frame from the original.

As discussed above, for each 4×4 block or each 8×8 block, there are up to nine (9) prediction directions (broadly referred to as different coding modes). For example, the 9 prediction directions comprise: 0 (vertical), 1 (horizontal), 2 (DC), 3 (diagonal_down-left), 4 (diagonal_down-right), 5 (vertical-right), 6 (horizontal-down), 7 (vertical-left) and 8 (horizontal-up). In one embodiment, the value preceding the direction name can be referred to as a coding mode index value. It should be noted that although the present invention is described in the context of the 9 possible coding mode directions as defined by the AVC standard, the present invention is not so limited. Namely, the present invention is not limited to these 9 possible coding mode directions and the present invention can be adapted to any number of coding mode directions for each block.

As discussed above, it is possible to compute a rate distortion (RD) cost for all of the nine possible coding modes. For example, a RD based mode selection method may attempt to find the minimum of cost of Lagrangian RD functional J for all possible coding modes for a block (e.g., 4×4, 8×8, or 16×16) in accordance with:

J=D+λ_{RD}×R (Eq. 1)

R=R_{R}+R_{M} (Eq. 2)

where D is the sum of square of difference between original pixels and the corresponding predicted pixels, λ_{RD} is the Lagrange multiplier and R is the required bits for encoding this block with one specific coding mode. In one embodiment, R comprises two parts, where R_{R} represents the number of bits for encoding the residual coefficients and R_{M} represents the number of bits for encoding the coding mode information (e.g., the number of bits needed to convey what coding mode was used to encode a particular block). As such, a full RD based mode selection method may employ Equation 1 to compute the RD cost for all possible coding modes. It should be noted that a brute force approach may implement a non-RD cost computation instead of an RD cost computation. Namely, the brute force approach may evaluate other costs associated with all the available coding modes instead of focusing on the RD costs associated with all the available coding modes. Unfortunately, the brute force approach is computationally expensive.

However, it has been observed that neighboring blocks (e.g., 4×4 and 8×8 blocks) are highly correlated. Using this premise, the coding modes of neighboring blocks are likely to be highly correlated as well.

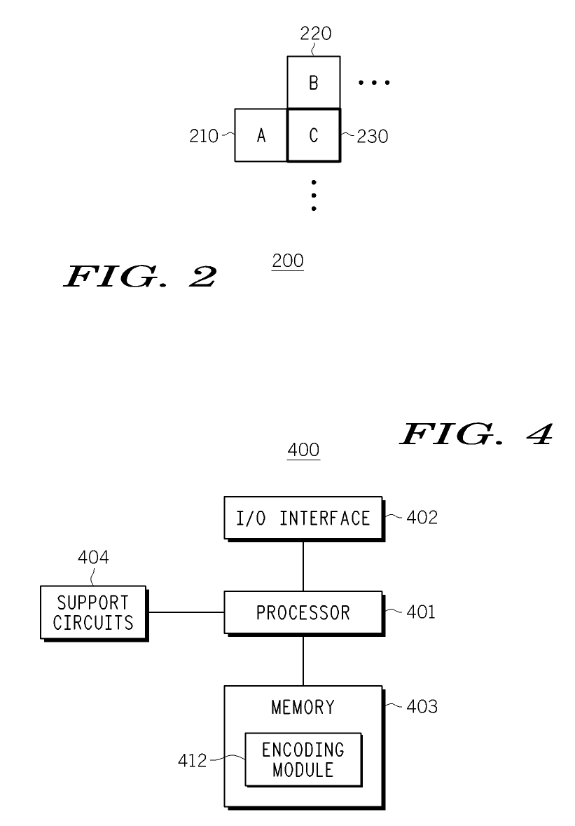

FIG. 2 illustrates a block diagram showing a plurality of neighboring blocks, e.g., a plurality of 4×4 blocks, of a current frame to be encoded. In one embodiment, a current coding mode for block C 230 needs to be determined, whereas the coding mode for block A 210 (a left block), and the coding mode for block B 220 (a top block) have already been determined. If neighboring blocks are highly correlated, then a coding mode (e.g., referred to as a most probable mode (MPM)) for the current block C 230 can be determined in accordance with the coding modes that have already been selected for block A and block B. In one embodiment, the MPM for a current block can be expressed as:

MPM=min(mode_{—}A, mode_{—}B) (Eq. 3)

where mode_A represents a coding mode index value for the coding mode selected for block A, and mode_B represents a coding mode index value for the coding mode selected for block B.

To illustrate, if the mode_A for block A 210 has a coding mode index value of “2” (e.g., DC), and if the mode_B for block B 220 has a coding mode index value of “3” (e.g., diagonal_down-left), then the MPM will be selected as “2” (e.g., DC). Similarly, if the mode_A for block A 210 has a coding mode index value of “4” (e.g., diagonal_down-right), and if the mode_B for block B 220 has a coding mode index value of “1” (e.g., horizontal), then the MPM will be selected as “1” (e.g., horizontal). It should be noted that if one or more neighboring blocks are not available, then the mode of unavailable neighboring block will be set to DC coding mode, e.g., “2”.

In one embodiment, the MPM is selected as the coding mode for a current block C 230. However, selecting the MPM as the coding mode for a current block may not be ideal in all situations. In other words, there is no assurance that the MPM is actually the most appropriate coding mode for the current block C.

FIG. 3 illustrates a flow diagram depicting an illustrative embodiment of a method 300 for determining a coding mode for a block in accordance with one or more aspects of the present invention. For example, method 300 can be implemented by an encoder.

Method 300 starts in step 305 and proceeds to step 310. In step 310, method 300 receives a current block of pixels and determines a coding block size for the current block, e.g., a macroblock or a sub-block. For example, a macroblock can be encoded in accordance with a plurality of 8×8 blocks, or a plurality of 4×4 blocks. It should be noted that step 310 can be deemed an optional step in the sense that the block size may have already been determined in accordance with another parameter, or it was determined by another encoding method or algorithm.

Once a block size has been determined, in step 320, method 300 selects a coding mode for a current block in accordance with one or more coding modes of at least one neighbor block. For example, in one embodiment, the MPM is selected as the coding mode for a current block in step 320.

In step 330, method determines whether a prediction measure for the selected coding mode is less than a threshold. Namely, in the present invention, selecting the MPM as the coding mode for the current block is only deemed as a starting point. The threshold is used to verify whether the MPM will be an appropriate coding mode for the current block. It should be noted that different prediction measures and their associated thresholds can be implemented in step 330 which will be disclosed below.

Let p_{i,j} and \hat{p}_{i,j} be the values of an original pixel at position (i,j) and its prediction pixel respectively. In one embodiment, three different prediction measures, namely, the maximum of the absolute values of the residuals (rₘ), SAD (sum of absolute differences), and prediction distortion (D) are defined as:

$$\begin{matrix}{r}_{m} = {max}_{i , j = 0}^{N} ( \vert {p}_{i , j} - {\hat{p}}_{i , j} \vert ) & ( Eq . 4 ) \\ S A D = {\sum }_{i = 0}^{N} {\sum }_{j = 0}^{N} \vert {p}_{i , j} - {\hat{p}}_{i , j} \vert & ( Eq . 5 ) \\ D = {\sum }_{i = 0}^{N} {\sum }_{j = 0}^{N} {( {p}_{i , j} - {\hat{p}}_{i , j} )}^{2} & ( Eq . 6 )\end{matrix}$$

where N is 4 for 4×4 block and 8 for 8×8 block.

For each of the prediction measures as disclosed in Equations 4-6, a threshold can be set that can be used to quickly determine that the resulting transformed and quantized coefficients will likely contain all zeros. More specifically, for a 4×4 block, if any of the following three conditions or thresholds is satisfied, the corresponding 4×4 block will have all-zero coefficients after transformation and quantization:

$${r}_{m} 〈 ( \frac{h - f}{16 {M}_{3}} ) \qquad ( Eq . 7 )$$

$$\begin{matrix}S A D 〈 ( \frac{h - f}{4 {M}_{1}} ) & ( Eq . 8 ) \\ D 〈 {( \frac{h - f}{10 {M}_{1}} )}^{2} for Q \%6 = \{ 0 , 2 , 4 \} , or D 〈 {( \frac{h - f}{4 {M}_{3}} )}^{2} for Q \%6 = \{ 1 , 3 , 5 \} . & ( Eq . 9 )\end{matrix}$$

where

h=2^{└Q/6┘+15},

f=h/3
└.┘ is the floor operator,
Q is the quantization parameter applied for the 4×4 block, and
M₁,M₃ are constants associated with 4×4 integer transform and their values are dependent upon the Q value.

Similarly, for 8×8 block, if any of the following three conditions or thresholds is satisfied, the corresponding 8×8 block will have all-zero coefficients after transformation and quantization:

$$\begin{matrix}{r}_{m} 〈 ( \frac{h - f}{64 {M}_{1}} ) & ( Eq . 10 ) \\ S A D 〈 ( \frac{h - f}{2.25 {M}_{2}} ) & ( Eq . 11 ) \\ D < {( \frac{h - f}{C} )}^{2} & ( Eq . 12 )\end{matrix}$$

where

h=2^{└Q/6┘+16},

f=h/3
└.┘ is the floor operator,
Q is the quantization parameter applied for the 8×8 block,
M₁,M₂, and C are constants associated with 8×8 integer transform and their values are dependent upon the Q value.

In one embodiment, the components on the right side of Equations 7-12 are constants depending upon the value of Q, and they can be pre-computed. Thus, these values can be stored in a look-up table.

In one embodiment, for 4×4 the level scale constant M_{b} is an element m_{ab} of the matrix M below where the row a=1+(Q%6), and column b=1+(i%2)+(j%2) of M, and % is the modulo operator. Matrix M is:

$$M = \begin{matrix}Q \%6 \\ 0 \\ 1 \\ 2 \\ 3 \\ 4 \\ 5\end{matrix} {[ \begin{matrix}5243 & 8066 & 13107 \\ 4660 & 7490 & 11916 \\ 4194 & 6554 & 10082 \\ 3647 & 5825 & 9362 \\ 3355 & 5243 & 8192 \\ 2893 & 4559 & 7282\end{matrix} ]}^{\begin{matrix}{M}_{1} & {M}_{2} & {M}_{3}\end{matrix}} . \qquad ( Eq . 13 )$$

In another embodiment, for 8×8 the level scale constant M_{b}=m_{ab}, an element of the matrix M=[m_{ab}] below where the row a=1+(Q%6), and column b of M is defined in (Eq. 15) below. Matrix M is:

$$M = \begin{matrix}Q \%6 \\ 0 \\ 1 \\ 2 \\ 3 \\ 4 \\ 5\end{matrix} {[ \begin{matrix}13107 & 11428 & 20972 & 12222 & 16777 & 15481 \\ 11916 & 10826 & 19174 & 11058 & 14980 & 14290 \\ 10082 & 8943 & 15978 & 9675 & 12710 & 11985 \\ 9362 & 8228 & 14913 & 8931 & 11984 & 11259 \\ 8192 & 7346 & 13159 & 7740 & 10486 & 9777 \\ 7282 & 6428 & 11570 & 6830 & 9118 & 8640\end{matrix} ]}^{\begin{matrix}{M}_{1 } & {M}_{2} & {M}_{3} & {M}_{4} & {M}_{5} & {M}_{6}\end{matrix}} \qquad ( EQ . 14 )$$

Here M₁ is an element of M from a given row (determined by Q%6) and column 1 of M, and similarly for M2, . . . ,M6. Variable b is:

$$b = \{ \begin{matrix}1 & for ( i , j ) with & i = [ 1 , 5 ] , j = [ 1 , 5 ] \\ 2 & for ( i , j ) with & i = [ 2 , 4 , 6 , 8 ] , j = [ 2 , 4 , 6 , 8 ] \\ 3 & for ( i , j ) with & i = [ 3 , 7 ] , j = [ 3 , 7 ] \\ 4 & for ( i , j ) with & \begin{matrix}( i = [ 1 , 5 ] , j = [ 2 , 4 , 6 , 8 ] ) , \\ ( i = [ 2 , 4 , 6 , 8 ] , j = [ 1 , 5 ] )\end{matrix} \\ 5 & for ( i , j ) with & \begin{matrix}( i = [ 1 , 5 ] , j = [ 3 , 7 ] ) , \\ ( i = [ 3 , 7 ] , j = [ 1 , 5 ] )\end{matrix} \\ 6 & for ( i , j ) with & \begin{matrix}( i = [ 3 , 7 ] , j = [ 2 , 4 , 6 , 8 ] ) , \\ ( i = [ 2 , 4 , 6 , 8 ] , j = [ 3 , 7 ] )\end{matrix}\end{matrix} . \qquad ( Eq . 15 )$$

For different quantization Q, the constant C is different as follows:

$$C = \{ \begin{matrix}6.325 {M}_{5} & Q \%6 = 0 \\ 9.031 {M}_{2} & Q \%6 = 1 \\ 8.5 {M}_{4} & Q \%6 = 2 \\ 8.5 {M}_{4} & Q \%6 = 3 \\ 9.031 {M}_{2} & Q \%6 = 4 \\ 8 {M}_{1} & Q \%6 = 5\end{matrix} . \qquad ( Eq . 16 )$$

It should be noted that the various values for Mₙ and C as disclosed above are only illustrative. Namely, the present invention is not limited by the specific values selected for these constants.

Returning to step 330, depending on the prediction measure that is employed, the method 300 will query whether a prediction measure calculated for the current block is below a corresponding threshold. In other words, since these thresholds are selected in a manner that will indicate whether a block will produce all zero coefficients after transformation and quantization, then a prediction measure for the current block having a value that is less than the corresponding threshold will indicate that the MPM selected for the current block will produce all zero coefficients. A coding mode that will generate all zero coefficients after transformation and quantization for a current block is a desirable result since it indicates a very efficient coding mode for this current block, i.e., no bits will be spent to encode the coefficients of the residual signal for this current block. As such, if the query at step 330 is affirmatively answered, then the method proceeds to step 335. If the query at step 330 is negatively answered, then the method proceeds to step 340.

In step 335, the coding mode indicated by the MPM will be selected as the coding mode for the current block. Namely, the presumption that the coding modes of neighboring blocks are highly correlated has now been confirmed via a verification that the MPM when applied to the current block will produce all zero coefficients.

In step 340, the method applies a transformation (e.g., DCT transform and the like) to the coefficients of the residual signal associated with the correct block. It should be noted that the threshold is selected in step 330 such that a prediction measure that is less than the threshold is guaranteed to produce all zero coefficients using the coding mode indicated by the MPM. However, since the MPM did not produce a prediction measure that is less than the threshold as defined in step 330, it does not necessarily mean that the coding mode as indicated by the MPM will not produce all zero coefficients after transformation and quantization. As such, transformation and quantization are performed to see whether the MPM is still an appropriate coding mode for the current block.

In step 350, the method 300 applies a quantization to the transformed coefficients. The selection of a particular quantization parameter is dependent on the specific requirements of an application.

In step 360, the method 300 queries whether all of the coefficients after the quantization have zero values. If the query at step 360 is affirmatively answered, then the method proceeds to step 335. If the query at step 330 is negatively answered, then the method proceeds to step 370. Thus, if all the coefficients are zero, then the MPM is an appropriate coding mode for current block and will be selected as the coding mode for the current block.

In step 370, since the MPM did not produce all zero coefficients, then a cost, e.g., a rate-distortion cost or a non-RD cost is performed for each of the available coding modes for the current block. Namely, it will be necessary to compute the rate-distortion costs or non-RD costs for all of the available coding modes in order for the method 300 to determine an appropriate coding mode for the current block.

In step 380, the method 300 will select a coding mode for the current block based on a lowest cost. In other words, a coding mode having a lowest rate-distortion cost or non-RD cost among all of the other computed costs will be selected as the coding mode for the current block. Method 300 ends in step 395.

In sum, the present invention starts by assigning the MPM as the coding mode for a current block and then verifies this selection via a threshold to ensure that the MPM will produce all zero coefficients for the current block. If the threshold is not met, the method will then apply a transformation and quantization to see whether the MPM will still produce all zero coefficients. If the MPM does not produce all zero coefficients, then and only then, will the computationally expensive rate-distortion or non-RD selection method for all possible modes be deployed.

It should be noted that although not specifically specified, one or more steps of method 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3 that recite a determining operation or involve a decision, do not necessarily require that both branches of the determining operation be practiced. In other words, one of the branches of the determining operation can be deemed as an optional step.

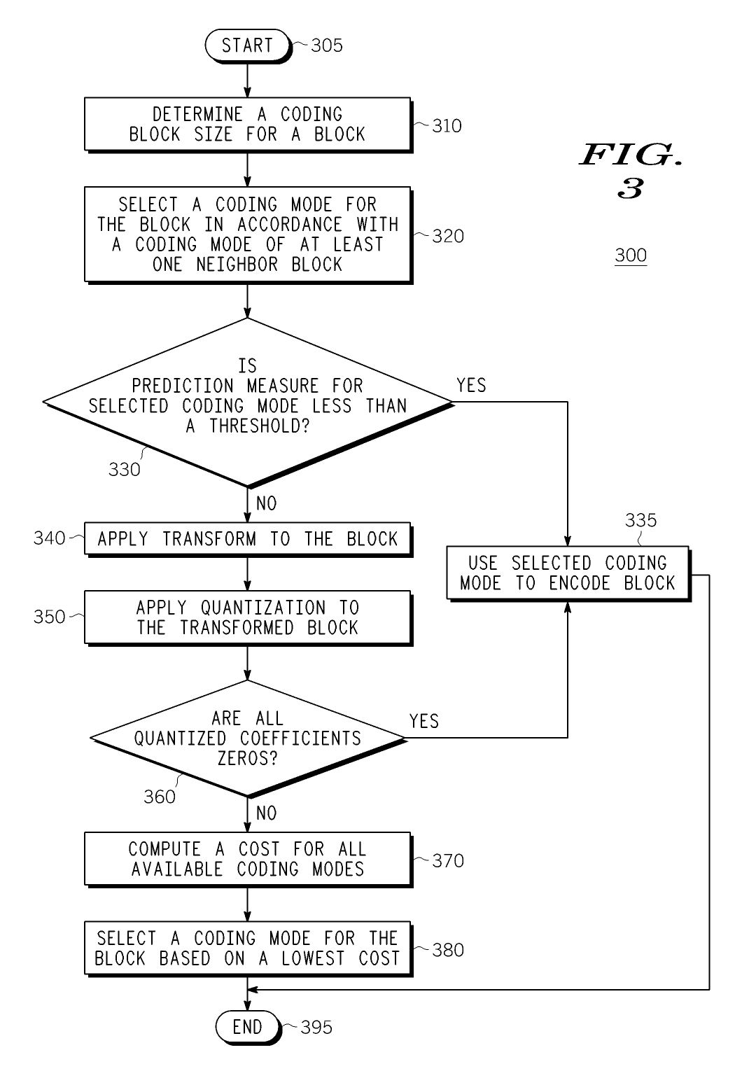

FIG. 4 is a block diagram depicting an exemplary embodiment of a video encoder 400 in accordance with one or more aspects of the invention. In one embodiment, the video encoder 400 includes a processor 401, a memory 403, various support circuits 404, and an I/O interface 402. The processor 401 may be any type of processing element known in the art, such as a microcontroller, digital signal processor (DSP), instruction-set processor, dedicated processing logic, or the like. The support circuits 404 for the processor 401 may include conventional clock circuits, data registers, I/O interfaces, and the like. The I/O interface 402 may be directly coupled to the memory 403 or coupled through the processor 401. The I/O interface 402 may be coupled to a frame buffer and a motion compensator, as well as to receive input frames. The memory 403 may include one or more of the following random access memory, read only memory, magneto-resistive read/write memory, optical read/write memory, cache memory, magnetic read/write memory, and the like, as well as signal-bearing media as described below.

In one embodiment, the memory 403 stores processor-executable instructions and/or data that may be executed by and/or used by the processor 401 as described further below. These processor-executable instructions may comprise hardware, firmware, software, and the like, or some combination thereof. Modules having processor-executable instructions that are stored in the memory 403 may include encoding module 412. For example, the encoding module 412 is configured to perform the method 300 of FIG. 3. Although one or more aspects of the invention are disclosed as being implemented as a processor executing a software program, those skilled in the art will appreciate that the invention may be implemented in hardware, software, or a combination of hardware and software. Such implementations may include a number of processors independently executing various programs and dedicated hardware, such as ASICs.

An aspect of the invention is implemented as a program product for execution by a processor. Program(s) of the program product defines functions of embodiments and can be contained on a variety of signal-bearing media (computer readable media), which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

What is claimed is:

1. A method for processing an input image, comprising:
receiving a block of pixels from said input image;
selecting a coding mode for the block of pixels based on at least one coding mode of at least one neighbor block of said block of pixels;
determining whether said coding mode will result in all zero coefficients for said block of pixels; and
selecting said coding mode for said block of pixels if said coding mode will result in all zero coefficients for said block of pixels.

2. The method of claim 1, wherein said at least one coding mode of at least one neighbor comprises a most probable mode (MPM).

3. The method of claim 2, wherein said at least one neighbor block comprises a top neighbor block and a left neighbor block.

4. The method of claim 3, wherein said MPM is selected in accordance with a minimum function that is applied to a coding mode index value of said top neighbor block and a coding mode index value of said left neighbor block.

5. The method of claim 1, wherein said determining whether said coding mode will result in all zero coefficients comprises:
computing a prediction measure for said block of pixels; and
comparing whether said prediction measure is less than a threshold.

6. The method of claim 5, wherein said prediction measure comprises at least one of: a maximum of absolute values of the residuals prediction measure, a sum of absolute differences prediction measure, or a prediction distortion prediction measure.

7. The method of claim 1, further comprising:
if said coding mode cannot be determined to generate all zero coefficients for said block of pixels, then applying a transformation to a residual signal of said block to generate transformed coefficients, and applying a quantization to said transformed coefficients to generate quantized transformed coefficients.

8. The method of claim 7, further comprising:
determining whether all of said quantized transformed coefficients are zeros; and
selecting said coding mode for said block of pixels if all of said quantized transformed coefficients are zeros.

9. The method of claim 8, further comprising:
if said quantized transformed coefficients are not all zeros, then computing a cost for all available coding modes for said block of pixels, and selecting one of said available coding modes for said block of pixels based on a lowest cost.

10. The method of claim 9, wherein said available coding modes comprise: a vertical coding mode, a horizontal coding mode, a DC coding mode, a diagonal_down-left coding mode, a diagonal_down-right coding mode, a vertical-right coding mode, a horizontal-down coding mode, a vertical-left coding mode or a horizontal-up coding mode.

11. The method of claim 1, wherein said input image is processed in an H.264 compliant encoder or an Advanced Video Coding (AVC) compliant encoder.

12. The method of claim 1, wherein said block of pixels comprises a 4×4 block of pixels or a 8×8 block of pixels.

13. A computer readable medium having stored thereon instructions that when executed by a processor cause the processor to perform a method for processing an input image, comprising:
receiving a block of pixels from said input image;
selecting a coding mode for the block of pixels based on at least one coding mode of at least one neighbor block of said block of pixels;
determining whether said coding mode will result in all zero coefficients for said block of pixels; and
selecting said coding mode for said block of pixels if said coding mode will result in all zero coefficients for said block of pixels.

14. The computer readable medium of claim 13, wherein said at least one coding mode of at least one neighbor comprises a most probable mode (MPM).

15. The computer readable medium of claim 14, wherein said at least one neighbor block comprises a top neighbor block and a left neighbor block.

16. The computer readable medium of claim 15, wherein said MPM is selected in accordance with a minimum function that is applied to a coding mode index value of said top neighbor block and a coding mode index value of said left neighbor block.

17. The computer readable medium of claim 13, wherein said determining whether said coding mode will result in all zero coefficients comprises:
computing a prediction measure for said block of pixels; and
comparing whether said prediction measure is less than a threshold.

18. The computer readable medium of claim 17, wherein said prediction measure comprises at least one of: a maximum of absolute values of the residuals prediction measure, a sum of absolute differences prediction measure, or a prediction distortion prediction measure.

19. The computer readable medium of claim 13, further comprising:
if said coding mode cannot be determined to generate all zero coefficients for said block of pixels, then applying a transformation to a residual signal of said block to generate transformed coefficients, and applying a quantization to said transformed coefficients to generate quantized transformed coefficients.

20. The computer readable medium of claim 19, further comprising:
determining whether all of said quantized transformed coefficients are zeros; and
selecting said coding mode for said block of pixels if all of said quantized transformed coefficients are zeros.

21. The computer readable medium of claim 20, further comprising:
if said quantized transformed coefficients are not all zeros, then computing a cost for all available coding modes for said block of pixels, and selecting one of said available coding modes for said block of pixels based on a lowest cost.

22. The computer readable medium of claim 21, wherein said available coding modes comprise: a vertical coding mode, a horizontal coding mode, a DC coding mode, a diagonal_down-left coding mode, a diagonal_down-right coding mode, a vertical-right coding mode, a horizontal-down coding mode, a vertical-left coding mode or a horizontal-up coding mode.

23. An apparatus for processing an input image, comprising:
a memory for receiving a block of pixels from said input image; and
a processor for selecting a coding mode for the block of pixels based on at least one coding mode of at least one neighbor block of said block of pixels, for determining whether said coding mode will result in all zero coefficients for said block of pixels, and for selecting said coding mode for said block of pixels if said coding mode will result in all zero coefficients for said block of pixels.

24. The apparatus of claim 23, wherein said at least one coding mode of at least one neighbor comprises a most probable mode (MPM).

25. The apparatus of claim 23, wherein said determining whether said coding mode will result in all zero coefficients comprises:
computing a prediction measure for said block of pixels; and
comparing whether said prediction measure is less than a threshold.
